(19) United States
(12) Patent Application Publication
(10) Pub. No.: US 2022/0177349 A1
(43) Pub. Date: Jun. 9, 2022

(54) RADIATION SHIELDING GLASS ARTICLES

(71) Applicant: CORNING INCORPORATED, Corning, NY (US)

(72) Inventors: Pierre-Jean Baron, Bois Le Roi (FR); Michele Marie-Louise Fredholm, Vulaines sur Seine (FR); Michael Lucien Genier, Horseheads, NY (US); Charlotte Andree Ingold, Fontainebleau (FR); Valerie Laforgue, Fontainebleau (FR); Kevin Robert Claude Michel, Montigny-sur-Loing (FR); Ludovic Guillaume Panard, Vulaines Sur Seine (FR); Wilfried Guy Marcel Tribaudot, Saint Mammes (FR)

(21) Appl. No.: 17/366,893

(22) Filed: Jul. 2, 2021

Related U.S. Application Data
(60) Provisional application No. 63/048,416, filed on Jul. 6, 2020.

(51) Int. Cl. C03C 3/072; C03C 3/07; C03C 4/18; C03C 4/08; G21F 1/06; B32B 17/06; C03B 23/203; C03C 21/00

(52) U.S. Cl. CPC C03C 3/072; C03C 3/07; C03C 4/18; C03C 4/087; G21F 1/12; B32B 17/06; C03B 23/203; C03C 21/005; C03C 2204/00; G21F 1/06

(57) ABSTRACT

Radiation shielding glass articles with thin glass faceplates that improve transmission are disclosed. A radiation shielding glass article includes a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass.

### CROSS-REFERENCE TO RELATED APPLICATIONS

This application claims the benefit of priority under 35 U.S.C. § 119 of U.S. Provisional Application Ser. No. 63/048,416 filed on Jul. 6, 2020, the content of which is relied upon and incorporated herein by reference in its entirety.

### BACKGROUND

### Field

This invention relates to a radiation shielding glass article, and in particular to radiation shielding glass articles with thin glass faceplates that improve transmission, and that possess surfaces that can withstand damage such as abrasion, scratches and repeated cleaning with cleaning agents, and that provide antimicrobial properties.

### Technical Background

Radiation shielding materials are well known and are used in many applications to shield personnel and sensitive equipment from damaging radiation. In many applications, X-ray or gamma-ray shielding is provided by a metallic lead (Pb) sheets of a specific thickness that are used to block specific energy levels of X-ray or Gamma-ray radiation. When optical transparency is required, glass with high PbO content is often used. Applications include viewing windows for x-ray rooms, screens for medical diagnostics, protection windows in laboratories, lenses for safety goggles and industrial applications using x-ray screens. One such radiation shielding glass is readily available from the applicant under the trade marks Corning® Med-X® Glass and Corning® Med-Gamma® Glass for x-ray and gamma ray shielding and that has a density of 4.8 g/cm³ and is produced in various shapes, typically rectangular, with the thickness varied to meet the application.

Commercially available Corning® Med-X® Glass and Corning® Med-Gamma® Glass shielding glass bodies are made from high PbO content glass. The raw materials are prepared, melted, formed and cooled into a transparent glass mass. Further processing of the glass mass by cutting, sawing and grinding occurs to shape the glass mass into the specifically desired shaped body. The thickness of the Corning® Med-X® Glass and Corning® Med-Gamma® Glass shielding glass bodies depends on the X-ray or Gamma ray protection needed for the application. Corning® Med-X® Glass and Corning® Med-Gamma® Glass shielding glass bodies are made with thicknesses ranging from 3.5 mm to 60 mm. The Corning® Med-X® Glass and Corning® Med-Gamma® Glass shielding glass bodies are further abrasively polished with CeO₂ slurry to reduce surface defect in preparation for use as a transparent radiation shielding glass body.

The glasses with high PbO content are highly susceptible to staining by acids and alkalis because of the high lead content and so when it is to be used in humid environments permanent structural or surface damage can occur, thereby reducing the transparency and of the object.

Additionally, glasses with high PbO content are relatively soft and are easily damaged by contact. Accidental and deliberate mechanical contact with the transparent radiation shielding glass body by harder objects can often results in the creation of surface damage. Additionally, frequent surface cleaning leads to scratches and digs, while accidental mechanical impact damage can result in potentially catastrophic structural cracks. The radiation shielding glass bodies are thus not suitable in certain glazing applications where use may require higher transmission, possession of surfaces that can withstand damage from humid environments, mechanical abrasion or scratches from repeated cleaning with cleaning agents, mechanical impact or that require antimicrobial properties when in use.

PCT application WO2004087414A2 contains a laminated radiation shielding glass article where at least one additional layer is added to the radiation shielding glass to form a radiation shielding glass articles with certain desirable properties. WO2004087414A2 describes a highly thermally insulating or fire-resistant laminate consisting of a single layer of radiation resistant Med-X glass laminated with a soda lime glass layer, which has between the glass layers a joining layer of material which imparts fire resistant properties which are used to form fire screening glazings. Commonly used interlayer materials are intumescent materials, epoxy resin materials and hydrogels (also known as aqueous transparent gels)—either organic, inorganic or a mixture of the two—which are used to make translucent glazings. The benefit of such a laminate is that when exposed to fire, the combined water in the hydrated sodium silicate layer is driven off, and the interlayer foams and the material is converted into a porous opaque mass which is very effective as a thermal barrier. The foam assists in preserving the structural integrity of the laminate for a longer period than conventional interlayers (e.g. polyvinyl butyral (PVB)), thereby maintaining a barrier to propagation of the fire to the non-fire side of the glass. The specific example cited include a three-layer structure of 7.5 mm Med-X glass, a 0.5 mm to 2.5 mm intumescent layer (hydrogels), followed by 2.6 mm soda-lime float glass.

Japanese application JP2008286787A attributed to Nippon Electric Glass Co., describes a light-weight Gamma radiation shielding laminate, with improved radiation shielding. The improvement described in the application is over Nippon Electric Glass Co.'s high PbO monolithic glass containing 55-80% PbO. The improvement is specially achieved by adding a cover plate material with an elevated BaO and SrO content. The BaO and SrO content of the cover plate provides added radiation shielding when mated in combination with the base high PbO radiation shielding glass layer. The specific laminate article described consists of a five-layer structure; a central core of the high PbO glass, containing 55-80% PbO adhered by PVB resin on both sides to glass the cover plates material containing a BaO and SrO content of 2-13%. The application teaches faceplates of 1 mm to 4 mm in thickness and teaches selecting cover plate with less than 1 mm thickness as insufficient to improve the protection level of the pane.

### SUMMARY

According to a first embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass.

According to a second embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, wherein the thickness of the first thin glass faceplate is less than 0.8 mm.

According to a third embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, wherein the thickness of the first thin glass faceplate is less than 0.5 mm.

According to a fourth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, wherein the thickness of the first thin glass faceplate is greater than 0.1 mm and less than 1.0 mm.

According to a fifth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, wherein the radiation shielding glass has a thickness of 3.5 mm to 60 mm.

According to a sixth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, wherein the radiation shielding glass comprises: SiO210-35 wt. %, PbO 50-80 wt. %, B2O3 0-10 wt. %, Al2O3 0-10 wt. %, BaO 0-20 wt. %, SrO 0-10 wt. %, the total of SrO+BaO 0-20 wt. %, Na2O 0-10 wt. %, K2O 0-10 wt. %, and Sb2O3 0-0.8 wt. %.

According to a seventh embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, where the radiation shielding glass comprises: SiO210-35 wt. %, PbO 55-80 wt. %, B2O3 0-10 wt. %, Al2O3 0-10 wt. %, BaO 0-10 wt. % SrO 0-10 wt. %, the total of SrO+BaO 0-20 wt. Na2O 0-10 wt. %, and K2O 0-10 wt. %.

According to an eighth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising a first bonding agent configured to bond the radiation shielding glass and the first thin glass faceplate.

According to a ninth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising a first bonding agent configured to bond the radiation shielding glass and the first thin glass faceplate, wherein the first bonding agent is disposed between the first surface of the radiation shielding glass and the second surface of the first thin glass faceplate.

According to a tenth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising a first bonding agent configured to bond the radiation shielding glass and the first thin glass faceplate, wherein the first bonding agent is disposed between the first surface of the radiation shielding glass and the second surface of the first thin glass faceplate, wherein the first bonding agent is polyvinyl butyral (PVB) or ethylene vinyl acetate (EVA).

According to an eleventh embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising a first bonding agent configured to bond the radiation shielding glass and the first thin glass faceplate, wherein the first bonding agent is disposed between the first surface of the radiation shielding glass and the second surface of the first thin glass faceplate, wherein the first bonding agent is low melting temperature glass frit.

According to a twelfth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, wherein the first thin glass faceplate is thermally bonded to the radiation shielding glass.

According to a thirteenth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising a first bonding agent configured to bond the radiation shielding glass and the first thin glass faceplate, wherein the first bonding agent is disposed between the first surface of the radiation shielding glass and the second surface of the first thin glass faceplate, wherein the first bonding agent is low melting temperature glass frit, further comprising a first cavity defined by a first surface of the radiation shielding glass, the first bonding agent, and the second surface of the first thin glass faceplate.

According to a fourteenth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising a first bonding agent configured to bond the radiation shielding glass and the first thin glass faceplate, wherein the first bonding agent is disposed between the first surface of the radiation shielding glass and the second surface of the first thin glass faceplate, wherein the first bonding agent is low melting temperature glass frit, further comprising a first cavity defined by a first surface of the radiation shielding glass, the first bonding agent, and the second surface of the first thin glass faceplate, wherein the first cavity is filled with a polymer material, wherein the polymer material is at least one of PVB, EVA, epoxy, and UV curable polymers.

According to a fifteenth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising a first bonding agent configured to bond the radiation shielding glass and the first thin glass faceplate, wherein the first bonding agent is disposed between the first surface of the radiation shielding glass and the second surface of the first thin glass faceplate, wherein the first bonding agent is low melting temperature glass frit, further comprising a first cavity defined by a first surface of the radiation shielding glass, the first bonding agent, and the second surface of the first thin glass faceplate, wherein the first cavity is filled with a fluid, wherein the fluid is at least one of air, nitrogen, argon, xenon, and index matching oil.

According to a sixteenth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, wherein the radiation shielding glass article has a Y D65 transmission of greater that 80%.

According to a seventieth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, wherein the radiation shielding glass article has a transmission of greater that 80% is maintained across the 450 nm to 800 nm spectral band.

According to an eighteenth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, wherein the first thin glass faceplate has a Vickers hardness of greater than 530.

According to a nineteenth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, wherein the first thin glass faceplate has an ion exchanged surface that has a Vickers hardness of greater than 600.

According to a twentieth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, where in the first thin glass faceplate has an ion exchanged surface that has a Vickers hardness of greater than 600 and has silver ions (Ag+) embedded in the ion exchanged surface.

According to a twenty-first embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass.

According to a twenty-second embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, further comprising a second bonding agent configured to bond the radiation shielding glass and the second thin glass faceplate.

According to a twenty-third embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the second bonding agent is disposed between the second surface of the radiation shielding glass and the first surface of the second thin glass faceplate.

According to a twenty-fourth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the second bonding agent is disposed between the second surface of the radiation shielding glass and the first surface of the second thin glass faceplate, wherein the second bonding agent is polyvinyl butyral (PVB) or ethylene vinyl acetate (EVA).

According to a twenty-fifth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the second bonding agent is disposed between the second surface of the radiation shielding glass and the first surface of the second thin glass faceplate, wherein the second bonding agent is low temperature melting frit.

According to a twenty-sixth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the second thin glass faceplate is thermally bonded to the radiation shielding glass.

According to a twenty-seventh embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the second bonding agent is disposed between the second surface of the radiation shielding glass and the first surface of the second thin glass faceplate, wherein the second bonding agent is low temperature melting frit, further comprising a second cavity defined by a second surface of the radiation shielding glass, the second bonding agent layer, and the first surface of the second thin glass faceplate.

According to a twenty-eight embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the second bonding agent is disposed between the second surface of the radiation shielding glass and the first surface of the second thin glass faceplate, wherein the second bonding agent is low temperature melting frit, further comprising a second cavity defined by a second surface of the radiation shielding glass, the second bonding agent layer, and the first surface of the second thin glass faceplate, wherein the second cavity is filled with a polymer material, wherein the polymer material is at least one of PVB, EVA, epoxy, and UV curable polymers.

According to a twenty-ninth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the second bonding agent is disposed between the second surface of the radiation shielding glass and the first surface of the second thin glass faceplate, wherein the second bonding agent is low temperature melting frit, further comprising a second cavity defined by a second surface of the radiation shielding glass, the second bonding agent layer, and the first surface of the second thin glass faceplate, wherein the second cavity is filled with a fluid, wherein the fluid is at least one of air, nitrogen, argon, xenon, and index matching oil.

According to a thirtieth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the thickness of the second thin glass faceplate is less than 0.8 mm.

According to a thirty-first embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the thickness of the second thin glass faceplate is less than 0.5 mm.

According to a thirty-second embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the thickness of the second thin glass faceplate is greater than 0.1 nm and less than 1.0 mm.

According to a thirty-third embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the radiation shielding glass article has a Y D65 transmission is greater than 80%.

According to a thirty-fourth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the radiation shielding glass article has a transmission greater than 80% is maintained across the 450 nm to 800 nm spectral band.

According to a thirty-fifth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the second thin glass faceplate has a Vickers hardness of greater than 530.

According to a thirty-sixth embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the second thin glass faceplate has an ion exchanged surface that has a Vickers hardness of greater than 600.

According to a thirty-seventh embodiment of the present disclosure, a radiation shielding glass article, comprising: a radiation shielding glass having a first surface and an opposing second surface; and a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass, further comprising, a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass, wherein the second thin glass faceplate having an ion exchanged surface has a Vickers hardness of greater than 600 and has silver ions (Ag+) embedded in the ion exchanged surface.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a 3-layer radiation shielding glass article, according to one or more embodiments described herein;

FIG. 2 schematically depicts a 5-layer radiation shielding glass article, according to one or more embodiments described herein;

FIG. 3 schematically depicts a 3-layer radiation shielding glass article with uniform thickness, but non-uniform areal bonding regions, according to one or more embodiments described herein;

FIG. 4 schematically depicts an additional 3-layer radiation shielding glass article, according to one or more embodiments described herein;

FIG. 5 graphically depicts transmission measurements of radiation shielding glass articles of various thicknesses, according to one or more embodiments described herein;

FIG. 6 graphically depicts transmission measurements of radiation shielding glass articles of various thicknesses, according to one or more embodiments described herein, compared to commercially available Corning® Med-X® Glass and Corning® Med-Gamma® Glass radiation shielding glass of similar thickness;

FIG. 7 graphically depicts transmission measurements of a radiation shielding glass articles, according to one or more embodiments described herein, compared to commercially available Counter Example 1, and Corning produced Counter Example 2, of similar thickness;

FIGS. 8A, 8B, 8C and 8D photographically depicts results from Bayer Abrasion testing on radiation shielding articles, according to one or more embodiments described herein, Counter Example 1, Corning produced Counter Example 2, and Counter Example 3.

### DETAILED DESCRIPTION

Reference will now be made in detail to embodiments of the radiation shielding article, embodiments of which are illustrated in the accompanying drawings. Whenever possible, the same reference numerals will be used throughout the drawings to refer to the same or like parts.

As used herein, “radiation shielding” means the ability to block or absorb high energy electromagnetic radiation, particularly X-ray radiation and Gamma ray radiation. Standard absorption equivalent level is measure and denoted in equivalent millimeters of Pb metal. (mm Pb).

As used herein, “visible” and “visible light” means the light within the 400 nm to 800 nm electromagnetic spectral band.

As used herein, “transmission” means the measurement ratio of amount of input light that impinges upon a solid, liquid, or gas media to that which passes through the solid, liquid, or gas.

As used herein, “antimicrobial glass” means a glass article with a surface that is characterized by an antimicrobial efficacy as defined by a 5 log reduction in a concentration of bacteria (e.g. Staphylococcus aureus, Enterobacter aerogenes, and Pseudomonas aeruginosa) under JIS Z 2801 (2000) testing conditions, or a 3 log reduction in a concentration of bacteria under modified JIS Z 2801 (2000) testing conditions.

As used herein, “chemically tempered” and “ion exchange” also abbreviated as “IOX” means the process of exchanging one element within a glass matrix for another larger element or ions supplied to the glass matrix by a molten salt bath. The ion exchange process substitutes larger Potassium (K⁺) ions from a heated KCl salt bath for smaller Sodium (Na⁺) ions contained within a surface layer of the glass surface placed within the molten salt bath. Ion exchange processes are designed improve the strength of the glass object.

As used herein, “thermally bond” means the process of joining adjacent layers by the application of sufficient heat and/or pressure to form a strong bond between the glass layers being bonded.

As used herein, “bonding agent” means a material, that acts to promote adhesion between glass layers, or that may provide a transition layer between one of more glass layers. The bonding agent may be organic such as PVB, or EVA or inorganic such as low melting temperatures glass frit.

As noted above, radiations shielding glass bodies are not suitable in certain glazing applications that require higher transmission, have possession of surfaces that can withstand damage from humid environments, mechanical abrasion or scratches or from repeated cleaning with cleaning agents, or mechanical impact or that require antimicrobial properties when in use.

To address these problems, advantageous radiation shielding glass articles have been created that provide a combination of higher transmission, improved cleanability, reduced susceptibility to scratched, abrasion, or impact damage. Additionally, advantageous radiation shielding glass articles have been created that provide a combination of higher transmission, improved cleanability, reduced susceptibility to scratched, abrasion, or impact damage, and that can provide efficaus antimicrobial properties.

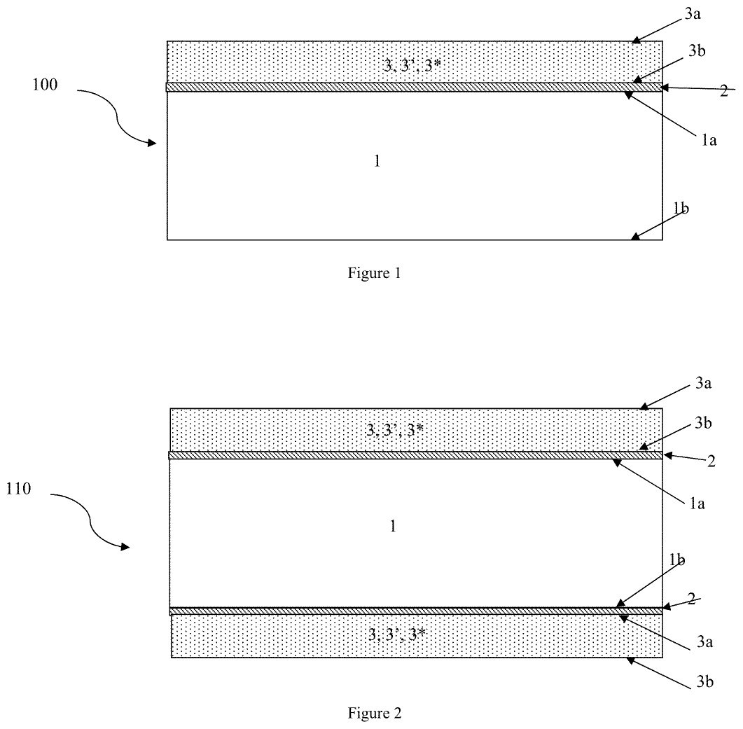

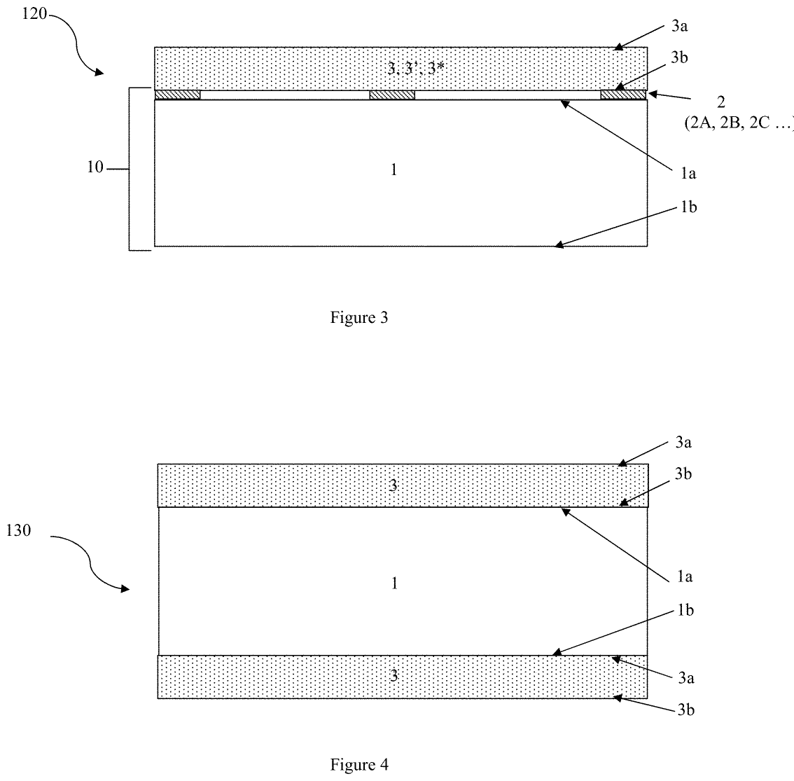

In each example there are various layer arrangements that describe the claimed radiation shielding glass articles. The radiation shielding glass article (100, 110, 120, 130) are illustrated in FIG. 1, FIG. 2, FIG. 3, and FIG. 4. Each radiation shielding glass article (100, 110, 120, 130) contains one or more layers of Corning® Med-X® Glass and Corning® Med-Gamma® Glass radiation shielding glass and one or more layers of a thin glass faceplate. In some examples the radiation shielding glass and the thin glass faceplate are bonded with a bonding agent, while in other instances the radiation shielding glass and the thin glass faceplate are bonded without a bonding agent.

Each figure shows a Corning® Med-X® Glass and Corning® Med-Gamma® Glass radiation shielding glass (1), having a first surface (1a) and a second surface (1b), opposing the first surface and a thickness (T) between the first surface (1a) and the second surface (1b). The first surface (1a) and the second surface (1b) were each provided with smoothly polished surfaces. The specific thickness of the Corning® Med-X® Glass and Corning® Med-Gamma®Glass radiation shielding glass (1) chosen is dependent upon several factors, to meet the technical need for the specific application and the level of high energy radiation (X-ray or Gamma ray) blockage needed. It should be clear that different applications require different thicknesses of the radiation shielding glass. It has been found that thicknesses of 3.5 mm to 60.0 mm were sufficient to provide x-ray and gamma ray protection in various applications for viewing windows for x-ray rooms, screens for medical diagnostics, protection windows in laboratories, lenses for safety goggles and industrial x-ray screening applications.

Each figure in addition contains a thin glass faceplate (3), having a first surface (3a) and a second surface (3b), opposing the first surface, the thin glass faceplate is selected from one of several families of glass sheets manufactured and sold by the applicant. The thin glass faceplate sheets produced have pristine surfaces that required no polishing and are manufactured in sizes up to 2200 mm×3150 mm. The glass sheets are all manufactured by using Corning's proprietary fusion overflow forming process that produces thin glass sheets with a highly uniform thickness and smooth surfaces that require no mechanical polishing to be used. Typical thicknesses produced by the fusion overflow forming process are greater than or equal to about 0.1 mm to less than or equal to about 2.0 mm in thickness. Reference can be made to many Corning patents related to the fusion over flow forming process starting from U.S. Pat. Nos. 3,338,696A and 3,682,609A up to and including a number of later improvements such as U.S. Pat. Nos. 7,386,999B2 and 8,490,432B2.

One exemplary variety of thin glass faceplate is made from an Alkaline boro-aluminosilicate glass manufactured and sold by the applicant as Corning® Architectural Technical Glazing (ATG).

Another exemplary variety of thin glass faceplate is made from a sodium aluminosilicate glass sold by the applicant under trade mark Gorilla® Glass. One commercially available variety of Gorilla Glass was used, specifically glass code 2319. Gorilla Glass can be used directly as formed, or Gorilla Glass can undergo an ion exchange process, which further improves the mechanical properties of the thin glass faceplate of this invention.

Another exemplary variety of thin glass faceplate is made from a sodium aluminosilicate glass that is ion exchangeable and sold by the applicant as an Antimicrobial Glass with the glass code 2320. When the Antimicrobial Glass is ion exchanged within an AgCl salt bath, Na⁺ ions are exchanged for Ag⁺ ion. The ion exchange process modifies the properties of the as formed sodium aluminosilicate glass sheet both improving the mechanical properties of the thin glass faceplate and providing desired antimicrobial properties, that will destructively interact with certain harmful microbes.

The thin glass faceplate is extracted from a larger as-manufactured glass sheets produced by the fusion overflow process. The as-manufactured glass sheets are cut by commercially know score and break technology into thin glass faceplate sheets of specified dimensions that match the size of a radiation shielding glass it will ultimately be bonded to. While score and break technology is quite common, other known process may in certain instances be more advantageous to use. One alternate means is the use of a lasers to ablate or induce damage to perforate a larger precursor glass sheet, providing a desirable means to extract thin glass faceplate for use in the radiation shielding glass articles of this application. The means described for extracting thin glass faceplate from larger glass sheets are only a few of the many described in the literature and should in no way be considered limiting.

As has been discussed earlier, Corning's proprietary fusion overflow forming process, used for forming the thin glass faceplate sheets can produce glass sheet thicknesses of, greater than or equal to about 0.1 mm to less than or equal to about 2.0 mm in thickness. During the production of the radiation shielding glass articles a certain range of thicknesses for the thin glass faceplate were found to yield advantageous results. The thin glass faceplate with thickness in the range of greater than or equal to about 0.1 to less than or equal to about 1.0 mm in thickness provided advantageous properties to the resulting radiation shielding glass articles. These properties include improved transmission, reduced overall thickness, structural stability, and lighter areal density for the radiation shielding glass articles.

In certain embodiments of the thin glass faceplate may have a thickness greater than or equal to 0.1 mm and less than or equal to 1.0 mm, greater than or equal to 0.1 mm and less than or equal to 0.9 mm, greater than or equal to 0.1 mm and less than or equal to 0.8 mm, greater than or equal to 0.1 mm and less than or equal to 0.7 mm, greater than or equal to 0.1 mm and less than or equal to 0.6 mm, greater than or equal to 0.1 mm and less than or equal to 0.5 mm, greater than or equal to 0.1 mm and less than or equal to 0.4 mm, greater than or equal to 0.1 mm and less than or equal to 0.3 mm, greater than or equal to 0.1 mm and less than or equal to 0.2 mm, greater than or equal to 0.2 mm and less than or equal to 1.0 mm, greater than or equal to 0.3 mm and less than or equal to 1.0 mm, greater than or equal to 0.4 mm and less than or equal to 1.0 mm, greater than or equal to 0.5 mm and less than or equal to 1.0 mm, greater than or equal to 0.6 mm and less than or equal to 1.0 mm, greater than or equal to 0.7 mm and less than or equal to 1.0 mm, greater than or equal to 0.8 mm and less than or equal to 1.0 mm, greater than or equal to 0.9 mm and less than or equal to 1.0 mm.

It has been found that in some applications using thin glass faceplate of the same composition and equal thickness is preferred. However, in other applications, there are benefits of using thin glass faceplate of differing compositions and equal thickness (3, 3′), in other applications, there are benefits of using thin glass faceplates of differing compositions and differing thicknesses (3, 3*). Many combinations of thin glass faceplates and radiation shielding glass (1) can be combined to form suitable radiation shielding glass articles.

Many methods for bonding glass are known in the prior art, some methods may include the use of bonding agents. Bonding of the thin glass faceplate layer(s) to the radiation shielding glass layer, is accomplished using one or more bonding processes. In certain situations, it is advantageous to use different bonding techniques at each different bonding interface.

Bonding agents are selected from one or more of polyvinyl butyral (PVB), Ethylene vinyl acetate (EVA), Low melting temperature glass frit, epoxy, and photocurable polymers. Each bonding agent requires a slightly different application and curing process. Each of these are known in the prior art.

One known process for bonding glass at relatively low temperatures, involves the use of a thermally cured polyvinyl butyral (PVB) resin film as a bonding agent (2) situated between the layers. This technique is widely used in the automotive glazing industry for automotive windshields. FIG. 1 and FIG. 2 illustrate useful configurations for the radiation shielding glass articles (100, 110).

FIG. 1 illustrates the radiation shielding glass article (100), prepared with a single radiation shielding glass layer (1) that is bonded to a singular thin glass faceplate (3) on either the first surface (1a) or the second surface (1b) of the single radiation shielding glass layer (1) by use of a bonding agent (2) in a bonding region between layers. The bonding agent (2) is a polyvinyl butyral (PVB) resin film made by an Eastman Chemical sold as Saflex® Clear product formulation RF41 with a thickness of 0.76 mm, that when laminated and thermally cured forms a strong bond between the adjacent first surface (1a) of radiation shielding glass layer (1) and the adjacent second surface (3b) of the thin glass faceplate (3).

FIG. 2 illustrates the radiation shielding glass article (110), prepared with a single radiation shielding glass layer (1) that is bonded to two thin glass faceplates (3, 3′, 3*), one on each side of the single radiation shielding glass layer (1) by use of a bonding agent (2) positioned in a bonding region, between the first surface (1a) of the single radiation shielding glass layer and the first and second surface (3a, 3b) of the first and second thin glass faceplates (3, 3′, 3*). The bonding agent (2) is a polyvinyl butyral (PVB) resin film made by an Eastman Chemical sold as Saflex® Clear, product formulation RF41 with a thickness of 0.76 mm, that when laminated and thermally cured forms a strong bond between the adjacent first surface (1a) of radiation shielding glass layer (1) and the adjacent second surface (3b) of the first thin glass faceplate (3, 3′, or 3*) and between the second surface (1b) of radiation shielding glass layer (1) and the adjacent first surface (3a) of the second thin glass faceplate (3, 3′, or 3*).

Table 1, further details specific examples of the radiation shielding glass articles produced according to FIG. 1 and FIG. 2. Each providing improved transmission and improved surfaces characteristic based on the thin glass faceplate selected.

TABLE 1

| | Example 1: | Example 2: | Example 3: | Example 4: | Example 5: | Example 6: | Example 7: |
|---|---|---|---|---|---|---|---|
| | MED-X | MED-X | MED-X | MED-X | MED-X | MED-X | MED-X |
| | thickness | thickness | thickness | thickness | thickness | thickness | thickness |
| Example | 4.10 mm | 8.60 mm | 9.60 mm | 8.30 mm | 8.30 mm | 5.19 mm | 5.66 mm |
| Radiation shielding | 6.40 | 10.90 | 11.90 | 10.65 | 11.22 | 7.35 | 7.98 |
| glass article - total | | | | | | | |
| thickness (mm) | | | | | | | |
| MED-X ®Radiation | 4.10 | 8.60 | 9.60 | 8.30 | 8.30 | 5.19 | 5.66 |
| shielding glass | | | | | | | |
| thickness (mm) | | | | | | | |
| Saflex ® PVB - RF41 | 0.76 | 0.76 | 0.76 | 0.76 | 0.76 | 0.38 | 0.76 |
| thickness (mm) | | | | | | | |
| First thin glass faceplate - | 0.40 | 0.40 | 0.40 | 0.40 | 0.70 | 0.70 | 0.40 |
| thickness (mm) | | | | | | | |
| First thin glass faceplate - | Corning | Corning | Corning | Corning | Corning | Corning | Corning |
| glass type | ATG | ATG | ATG | ATG | Gorilla | ATG | ATG |
| | | | | | Glass Code | | |
| | | | | | 2319 | | |
| Is first thin glass | N | N | N | N | N | N | N |
| faceplate ion | | | | | | | |
| exchanged? | | | | | | | |
| Second thin glass | 0.40 | 0.40 | 0.40 | 0.40 | 0.70 | 0.70 | 0.40 |
| faceplate - | | | | | | | |
| thickness | | | | | | | |
| (mm) | | | | | | | |
| Second thin glass | Corning | Corning | Corning | Corning | Corning | Corning | Corning |
| faceplate - | ATG | ATG | ATG | ATG | Gorilla | ATG | ATG |
| glass type | | | | | Glass | | |
| | | | | | Code 2319 | | |
| Is second thin glass | N | N | N | N | N | N | N |
| faceplate ion | | | | | | | |
| exchanged? | | | | | | | |

| | Example 8: | Example 9: | Example 10: | Example 11: | Example 12: | Example 13: |
|---|---|---|---|---|---|---|
| | MED-X | MED-X | MED-X | MED-X | MED-X | MED-X |
| | thickness | thickness | thickness | thickness | thickness | thickness |
| Example | 5.49 mm | 8.30 mm | 8.30 mm | 8.30 mm | 8.30 mm | 8.30 mm |
| Radiation shielding | 8.41 | 10.65 | 10.65 | 11.22 | 10.35 | 9.76 |
| glass article - total | | | | | | |
| thickness (mm) | | | | | | |
| MED-X ®Radiation | 5.49 | 8.30 | 8.30 | 8.30 | 8.30 | 8.30 |
| shielding glass | | | | | | |
| thickness (mm) | | | | | | |
| Saflex ® PVB - RF41 | 0.76 | 0.76 | 0.76 | 0.76 | 0.76 | 0.76 |
| thickness (mm) | | | | | | |
| First thin glass faceplate - | 0.70 | 0.40 | 0.40 | 0.70 | 0.70 | 0.70 |
| thickness (mm) | | | | | | |
| First thin glass faceplate - | Corning | Corning | Corning | Corning | Corning | Corning |
| glass type | ATG | Antimicrobial | Antimicrobial | Gorilla | ATG | ATG |
| | | Glass | Glass | Glass | | |
| | | Code 2320 | Code 2320 | Code 2319 | | |
| Is first thin glass | N | N | Y | Y | N | N |
| faceplate ion | | | | | | |
| exchanged? | | | | | | |
| Second thin glass | 0.70 | 0.40 | 0.40 | 0.70 | 0.40 | |
| faceplate - | | | | | | |
| thickness | | | | | | |
| (mm) | | | | | | |
| Second thin glass | Corning | Corning | Corning | Corning | Corning | |
| faceplate - | ATG | Antimicrobial | Antimicrobial | Gorilla | Antimicrobial | |
| glass type | | Glass | Glass | Glass | Glass | |
| | | Code 2320 | Code 2320 | Code 2319 | Code 2320 | |
| Is second thin glass | N | N | Y | Y | Y | |
| faceplate ion | | | | | | |
| exchanged? | | | | | | |

During the course our experimentation, we studied several commercially available products used for radiation shielding and one experimental product previously developed by the applicant.

The applicant presently sells Corning® Med-X® Glass and Corning® Med-Gamma® Glass radiation shielding glass (1) into certain markets and applications. Competitors produce radiation shielding products that are sold into certain markets and applications. These products including a glass laminate commercially produced by Nippon Electric Glass Co. Ltd (NEG) known as LX-57B (here after referred to as Counter Example 1), and a commercially available clear lead acrylic polymer with a thickness of 12.30 mm (here after referred to as Counter Example 3). The lead acrylic polymer product however has limited utility for x-ray radiation blocking applications due to the massively thick that would be needed, to be equivalent to thinner high PbO glass based products. The applicant also presents an experimental laminated radiation shielding article (here after referred to as Counter Example 2). Various measurement of Corning® Med-X® Glass and Corning® Med-Gamma® Glass (1), Counter Example 1, Counter Example 2, and Counter Example 3 are presented to juxtapose and further illuminate various improvements in the radiation shielding glass article (100, 110, 120, 130) of this application.

For purposes of clarity, the applicants Counter example 2 will now be described. Counter example 2 has the same basic structure in FIG. 2, so for illustrative purpose the drawing will be referred to. Counter example 2 as manufactured has an overall thickness of 15.10 mm. Counter example 2 comprises a single layer of commercially available Corning® Med-X® Glass and Corning® Med-Gamma® Glass radiation shielding glass (1) of 8.38 mm thick was bonded two thick soda-lime glass faceplates made from Nippon Sheet Glass' soda-lime float glass FL3, each faceplate with a thickness of 2.6 mm. The soda-lime faceplates were arranged one on each side of the single Corning® Med-X® Glass and Corning® Med-Gamma® Glass radiation shielding glass layer (1) and bonded with a polyvinyl butyral (PVB) resin with a thickness of 0.76 mm, that was thermally cured to form Counter example 2.

As previously discussed, radiation shielding glass articles in possession higher transmission are important for many applications where optical observation in the visible light spectrum is needed. In certain instance this is by direct line of sight of a physician or a technician, observing a person or object that will be exposed to radiation for diagnostic purposes. In other instances, the observer may indirectly be viewing the person of object by an imaging device, (e.g. photographic film, camera, CCD focal plane array) through a radiation shielding glass because the imaging film or device could be sensitive to high energy radiation. It is highly desirable for radiation shielding glass articles to in addition be in possession of surfaces that can withstand damage from humid environments, mechanical abrasion or scratches from repeated cleaning with cleaning agents, mechanical impact or that possess antimicrobial properties.

Measurements of transmission were conducted using a Cary 5000 UV-VIS-NIR Spectrometer from Agilent Technologies, successively measuring across the visible spectrum from 400 nm to 800 nm at spectral increments of 1 nm. The data was recorded, and graphic plots were prepared to illustrate both the deficiencies of Counter examples 1, Counter example 2, and the benefits of radiation shielding glass article (100, 110, 120, 130) of this application.

In order to fully illustrate the improved transmission of the radiation shielding glass article (100, 110, 120, 130) of this application, transmission samples from Examples 1 through 8 and Example 11 in Table 1 were extracted, and measured to provide Y D65(%) transmission values and for Examples 1 through 8 the transmission data was plotted across the full spectrum to provide a graphical display of the results. Y D65% refers to the integral optical transmission of the sample using CIE D65 illuminant (day light). Table 2 below quantifies the Y D65(%) transmission values for Examples 1 through 8 and Example 11 and in addition presents Haze measurements for certain Examples and Counter Examples tested with a Bayer Abrasion testing system.

TABLE 2

| | | Example 1: | Example 2: | Example 3: | Example 4: | Example 5: | Example 6: | Example 7: |
|---|---|---|---|---|---|---|---|---|
| | | MED-X | MED-X | MED-X | MED-X | MED-X | MED-X | MED-X |
| | | thickness | thickness | thickness | thickness | thickness | thickness | thickness |
| | Example | 4.10 mm | 8.60 mm | 9.60 mm | 8.30 mm | 8.30 mm | 5.19 mm | 5.66 mm |
| Transmission | Y D65(%) | 88.80 | 88.02 | 89.26 | 88.77 | 88.71 | 90.00 | 88.64 |
| Bayer Abrasion | Initial Haze | | | 0.57 | | | | |
| Testing | | | | | | | | |
| | Haze after 3600 cycles | | | 2.99 | | | | |
| | using Corundum sand | | | | | | | |
| | moving over surface | | | | | | | |

| | | | | Counter | | |
|---|---|---|---|---|---|---|
| | | Example 8: | Example 11: | Example 1: | Counter | |
| | | MED-X | MED-X | Competitor | Example 2: | Counter |
| | | thickness | thickness | laminated | Corning Trial | Example 3: |
| | Example | 5.49 mm | 8.30 mm | article | MED-X + SLG | Lead Acrylic |
| Transmission | Y D65(%) | 89.14 | 88.71 | 86.06 | 86.91 | 85.41 |
| Bayer Abrasion | Initial Haze | | | 0.43 | 0.38 | 1.22 |
| Testing | | | | | | |
| | Haze after 3600 cycles | | | 3.38 | 5.1 | 71.9 |
| | using Corundum sand | | | | | |
| | moving over surface | | | | | |

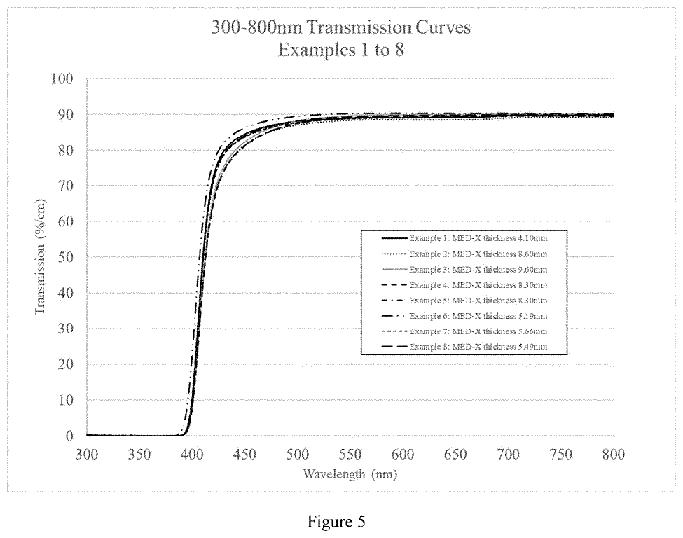

Now turning to FIG. 5 it shows the resulting full visible transmission curves of Examples 1 through 8, corresponding to radiation shielding glass articles (100, 110, 120, 130). As can be seen the transmission curves are highly aligned, each falling nearly on top of each other. The slight deviations are thought to be associated with the differing thicknesses of the radiation shielding glass (1) and the differing thicknesses of thin glass faceplate (3) used to manufacture each example. The main point to be taken from the plot is that the radiation shielding glass articles (100, 110, 120, 130) uniformly provide high visible transmission of greater than or equal to 87% in the spectral band of 450 nm to 800 nm.

To contrast the improved transmission in the radiation shielding glass articles (100, 110, 120, 130), the applicant prepared two samples of its commercially available Corning® Med-X® Glass and Corning® Med-Gamma® Glass radiation shielding glass as normally sold, with thicknesses of 4.0 mm and 8.5 mm for visible transmission measurements. The two samples are of identical type as the radiation shielding glass (1).

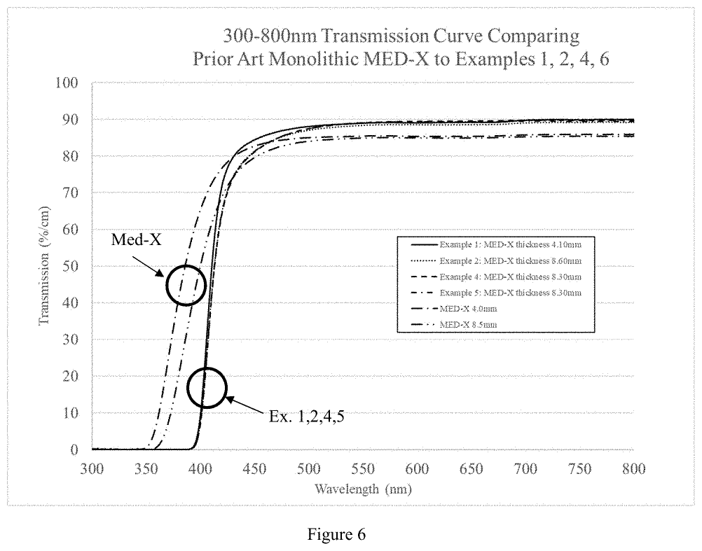

Visible transmission and Y D65(%) transmission was measured for the Corning® Med-X® Glass and Corning® Med-Gamma® Glass radiation shielding glass with thicknesses of 4.0 mm and 8.5 mm and are were reported in the Table 3, while the visible transmission data for each sample was graphically plotted in FIG. 6.

TABLE 3

| | Y D65 (%) |
|---|---|
| Sample | transmission |
| Med-X radiations shield glass 4.0 mm | 85.35 |
| Med-X radiations shield glass 8.5 mm | 84.71 |

As can be seen in Table 3 the Corning® Med-X® Glass and Corning® Med-Gamma® Glass radiation shielding glass produced low transmission around approximately 85%. FIG. 6 additionally includes the full visible spectrum transmission data for Example 1, Example 2, Example 4, and Example 5 from Table 2. The purpose of adding these four examples to FIG. 6 was to make a clear comparison that the improved transmission was achieved over the full visible spectrum for like thickness of radiation shielding glass articles (100, 110, 120, 130).

Further experiments and observations were conducted on Counter example 1 and Counter example 2. It was noticed that the glass faceplates used in each were thicker that those used in radiation shielding glass article (100, 110, 120, 130). On Counter example 1 the glass faceplates were measured to be 1.81 mm thick and on Counter example 2 the glass faceplates used were measured to be 2.6 mm thick.

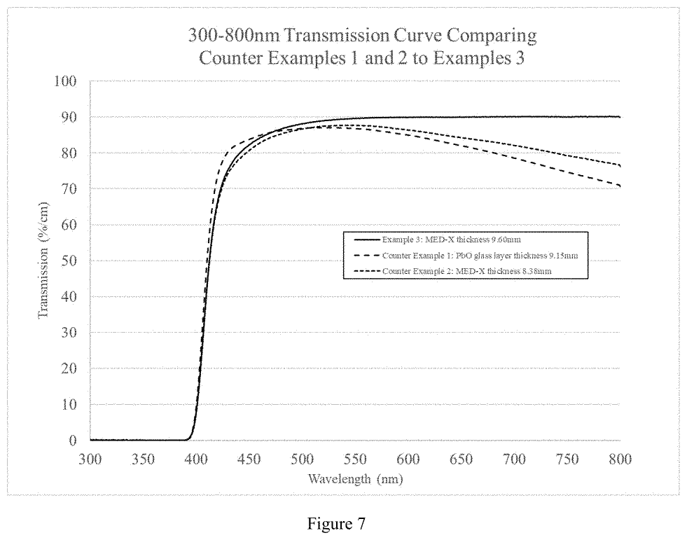

The applicant prepared two additional transmission samples one for each Counter example 1 and Counter example 2. Counter example 1 and Counter example 2 were measured in the same way as previously described. The Y D65(%) transmission values were collected and are reported in the Table 4 and full visible transmission data was graphically plotted in FIG. 7. A representative radiation shielding glass articles (100, 110, 120, 130), specifically Example 3 was added to Table 4 and FIG. 7 to further illustrate the significant transmission differences between the various designs.

TABLE 4

| | Y D65 (%) |
|---|---|
| Sample | transmission |
| Example 3 | 89.26 |
| Counter example 1 | 86.06 |
| Counter example 2 | 86.91 |

FIG. 7 shows the full visible spectrum for each of the three samples in Table 4. Clearly noticeable in FIG. 7 is the general downward shift in the curves for Counter example 1 and Counter example 2, which are trending to lower transmission at higher wavelengths in comparison to the representative radiation shielding glass articles, Example 3.

While not being held to a specific theory, the applicant believes the improved transmission is the direct result of the reduced thickness of the thin glass faceplate. Especially thin glass faceplates of less than 1.0 mm thick.

Is it known from optical theory reflection loss occur at is each surface that a transmitted light is directed toward, and that reflected light plus transmitted light must be equal to 100% to comport with the laws of energy conservation. In a perfect system with no loss, if a theoretical light beam is equal to 100% intensity when the light interacts with a first surface, 4% of that light is reflected backwards and 96% of the light is transmitted forward through a first surface of the perfect optical material with a thickness, to the next surface. At the second surface of perfect optical material has the same interaction where 4% of the 96% that was transmitted (3.84% of original 96%) is reflected leaving 92.16% (of the original 96%) light transmitted out of the optical material.

An important point in the discussion is that absorption loss in real materials including the thin glass faceplate (3) is not zero, and that absorption is proportional to the thickness of the optical pathlength the transmitted light travel within the thin glass faceplate (3). Thus, thin glass faceplates of less than or equal to 1.0 mm, provide reduced optical path lengths that advantageously deliver more transmitted light to the second surface (3b) of a thin glass faceplate that a thick glass faceplate. It should also be considered that reflected light at each surface goes through the same transmission and reflection phenomena many times at each optical interface, each time retroreflecting a small amount of the greater reflected light from the first surface (3a), back toward second surface (3b). These multiple retroreflections additively combine to increasing the final output light measured to determine the transmission of the radiation shielding glass article. While the retroreflections are small percentages, when thin glass faceplates are used, the overall pathlength the retroreflected light travels can be significantly reduced compared to a thick glass faceplate.

A second factor that was consider is the deliberate choice of using glass types with lower visible absorption when selecting the thin glass faceplates (3). Lower absorbing thin glass further enhance the transmissivity of the radiation shielding glass articles (100, 110, 120, 130). It was noticed that the thick glass faceplate of Comparative example 2, contained metal ions (e.g. Fe³⁺) that promote absorption. The absorption levels being much higher than the thin glass faceplate (3) used to fabricate the radiation shielding glass article (100, 110, 120, 130).

As previously stated in addition to the improved transmission obtained by radiation shielding glass article (100, 110, 120, 130), there are additional advantageous features desired in radiation shielding applications. The possession of surfaces that can withstand damage from humid environments, mechanical abrasion or scratches from repeated cleaning with cleaning agents, mechanical impact or that possess antimicrobial properties.

Further experiments were made on radiation shielding glass article (100, 110, 120, 130) and on the various counter examples to better illuminate the improved properties of the radiation shielding glass articles

Cleaning of the radiations shielding glass articles when they are installed is common placed. The radiations shielding glass articles when used as window or safety goggles are subject to repeated cleaning with a cleaning agents such as Windex®, water, ammonia, bleach, citric acid cleaners, or ozone, to remove dirt, dander, dust, microbes, biological fluids and other contaminates that my soil the radiations shielding glass articles when used.

The typical high PbO glasses stain and loses transparency when repeated cleaned. To avoid the staining, the soft scratch prone radiation shielding glass can be isolated from its environment with one or more faceplates less susceptible to the cleaning agents used. Several glass types can serve this purpose of physical isolation, including soda-lime glass. Adding the faceplate glass transferred the scratch and flaw damage problem from the radiation shield glass to a new faceplate glass element, preventing the staining problem.

It was found that the soda-lime glass was prone to produce surface flaws when the glass was repeated cleaned, or when regional and occasional deep point impact occurred. The presence of scratches and point impacts are widely known as key contributors of mechanical failure in glass. Deep impact damage flaws can cause catastrophic failure while light scratched may be able to be tolerated to some extent mechanically, but not optically. Corning has a long studied the fractology of glass, leading to many significant discoveries.

Corning produces several glasses that are suitable to be used as thin glass faceplates for radiations shielding glass articles with improved abrasion resistance. Specifically, Corning ATG glass, Corning Gorilla glass and Corning Antimicrobial glass each provide superior scratch and damage resistance to that of ordinary soda-lime glass.

Coming Gorilla Glass, glass code 2320, had been intensity studied and has been subject to numerous patent applications describing the composition, properties, manufacture, and processing of the glass. The most relevant US granted patent references are incorporated herein, U.S. Pat. Nos. 8,586,492, 9,290,407, RE47837, U.S. Pat. Nos. 8,969,226, 9,809,487, U.S. Ser. No. 10/464,839, U.S. Pat. No. 8,652,978, U.S. Ser. No. 10/364,178, U.S. Pat. Nos. 8,951,927, 9,822,032, U.S. Ser. No. 10/570,053, U.S. Pat. No. 8,946,103, and provide ample detail on glass composition, ion exchange processes, and the physical properties that lead the improve scratch and damage resistant surface when configured into of the radiation shielding glass articles of this application.

Corning Antimicrobial glass code 2319, had been intensity studied and has been subject to numerous patent applications describing the composition, properties, manufacture, and processing of the glass. The most relevant US granted patent references are incorporated herein, U.S. Pat. Nos. 9,290,413, 9,567,259, U.S. Ser. No. 10/155,691, U.S. Pat. Nos. 9,512,035, 9,731,998, and provide ample detail on glass composition, Ag⁺ ion exchange processes, the physical properties and the antimicrobial properties that lead the improve scratch and damage resistance, and antimicrobial surfaces when configured into of the radiation shielding glass articles of this application.

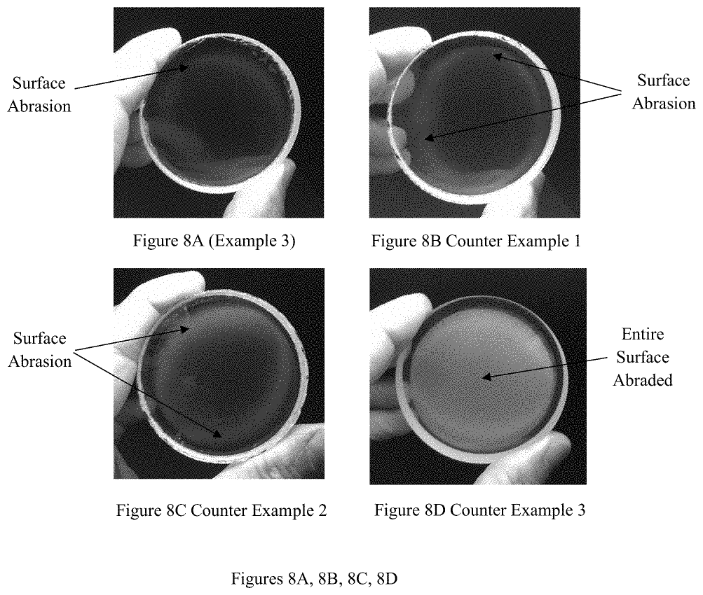

To further illustrate the improved mechanical performance of radiation shielding glass articles (100, 110, 120, 130), Bayer abrasion tests were conducted on radiation shielding glass article Example 3, Counter example 1, Counter example 2, Counter example 3. Bayer abrasion testing is known in the art and described in ASTM standard F735-94. Coming used Colts Laboratories Bayer Test Equipment with a corundum media that delivered 3600 oscillation for each test. The samples were measured for haze with a BYK Gardner haze meter both before and after the testing protocol and the results are reported in Table 2. In addition, photographic evidence of the Bayer abrasion tested samples are presented in FIGS. 8A, 8B, 8C, and 8D.

The photographic evidence provides a good sense of the range of abrasion damage possible. The most damaged sample as expected was the lead acrylic polymer illustrated in FIG. 8D, where the entire surface is heavily abraded by the test. As stated, earlier lead acrylic polymer is not suitable for thin faceplate applications and is only highlighted for the visual contrast to the glass faceplates being studied.

Turning to the images of the various glass faceplates that were tested, areas of surface abrasion are marked that can be clearly seen in the images. Counter example 2 (FIG. 8C—soda-lime faceplate) contains more damage than Counter example 1 (FIG. 8B—NEG LX-57B product), and likewise that counter example 1 (FIG. 8B—NEG LX-57B product), contains more damage than Example 3 (FIG. 8A), a radiation shielding glass article of this application. To more precisely illuminate the differences between the glass faceplates, we turn to the Haze measurements in Table 2. The Haze values are highly sensitive to a surface's conditions. Surface preparation, such as glass forming, or mechanical polishing can yield surface effects that can be measured by Haze measurements. Lower Haze values represent improved overall performance.

For viewing windows for x-ray rooms, screens for medical diagnostics, protection windows in laboratories, lenses for safety goggles and industrial x-ray screening applications, lower haze is highly desired.

As reported in Table 2, Example 3, a radiation shielding glass article of this application provides the lowest measured haze value of 2.99. Counter example 1 and the Counter example 2 were tested under identical conditions both yielded higher haze values of 3.38 and 5.1 respectively. When the delta haze (Haze_{final}−Hazeᵢₙᵢₜᵢₐₗ) is calculated, Example 3 yields the smallest increase in haze under the test conditions of 2.42, while the Counter example 1 yields an increase of 2.95 and the Counter example 3 yields an increase of 4.72. The hard corundum media used, induces scratches into the surface tested. Thus, the delta haze can be indicative of a surfaces ability to withstand damage from scratches and abrasion, such as that needed when glasses are subject to repeated cleaned of dirt, dander, dust, microbes, biological fluids and other contaminates when in use. Additionally, lower induced haze and delta haze result in lower scattering surfaces thus maintaining the higher transmission potential of the thin glass faceplate (3) of the radiation shielding glass articles (100, 110, 120, 130) of this application.

As noted above, lower delta haze is essentially the ability of a glass to resist scratches and damage. Certain examples of radiation shielding glass article (100, 110, 120, 130) were manufactured with thin glass faceplates (3) that were made from Corning Gorilla Glass, glass code 2320 or Corning Antimicrobial glass code 2319. In some instance the thin glass faceplates (3) were further processed by ion exchange methods in a salt bath to further improve the scratch resistance or to improve the antimicrobial properties of the at least one first surface of a thin glass faceplate (3, 3′, 3*).

Thin glass faceplates (3) in Examples 5 and 11 were made with ion exchangeable Gorilla glass code 2320. Further prepared were Examples 9, 10 and 13, that contain thin glass faceplates (3, 3′, 3*) made from at least one ion exchangeable Corning antimicrobial glass code 2319. Examples 9 and 10 were made with identical thin glass faceplates (3) that were made from ion exchangeable Corning antimicrobial glass code 2319, while Example 13 contained one thin glass faceplate (3′) made from Corning ATG glass and one thin glass faceplate (3*) that were made from ion exchangeable Corning antimicrobial glass code 2319. Example 13 is another example of radiation shielding glass article (100) where a single thin glass faceplates was used to meet the needs of a certain applications.

Both Corning Gorilla Glass code 2320 or Corning Antimicrobial glass code 2319 can be used in their pristine unpolished fusion drawn state as shown in Examples 5 and Example 9. Certain additional advantages can be achieved by ion exchanging the thin glass faceplate (3) imbuing it with improved mechanical performance and/or antimicrobial properties, while continuing to maintain the improve transmission performance advantage present in radiation shielding glass articles (100, 110, 120, 130), such as shown in the Y D65 transmission of Example 5, reported as 88.71% and that compares closely in FIG. 5 with the other example of the radiation shielding glass articles (100, 110, 120, 130) made with thin glass faceplates according to this application.

Certain thin glass faceplates made from ion exchangeable Corning Gorilla Glass code 2320 were subjected to additional processing via an ion exchange processes in a KCl salt bath. Additionally, thin glass faceplates made from ion exchangeable Corning antimicrobial glass code 2319 were subjected to additional processing via an ion exchange processes in a AgCl salt bath.

The ion exchange processes substitute larger Potassium (K⁺) ions from a heated KCl salt bath or larger Silver (Ag⁺) ions in a AgCl salt bath for smaller Sodium (Na⁺) ions contained within a surface of the thin glass faceplate (3). Either or both surfaces (3a, 3b) of a thin glass faceplate were placed in contact with a molten salt bath. The ion exchange process is well known in the art and documented in several of the referenced patents. Ion exchange of a compatible glass is a diffusion reaction, thus time and temperature along with the specific ionic salt used are the main contributors to the process. In all cases the thin glass faceplates that were ion exchanged produced an ion exchanged region starting from surface (3a, 3b) toward the depth of the thin glass faceplates as measured from the surface (3a, 3b). The depth of the ion exchanged region is denoted as a depth of layer (DOL). The DOL represents a maximum depth which a scratch, an abrasion, or an impact flaw can penetrate one of the surfaces (3a, 3b) of the thin glass faceplate (3), before the thin glass faceplate will yield to catastrophic failure. The ion exchange process increases the hardness, a mechanical property, of the surface regions, thus resisting the formation of scratch, abrasion and impact flaws.

To further highlight the improvements provided to the radiation shielding glass articles (100, 110, 120, 130) made by using ion exchanged thin glass faceplates (3, 3′, 3*), measurements of Vickers Hardness on various Examples and Counter examples were made.

Vickers hardness testing using a pyramidal diamond indenter is a well-known testing technique for testing materials. Vickers testing is described in ASTM E 384, Standard Test Method for Microindentation Hardness of Materials. We used a 200 g load, 25 sec dwell for the test performed. Hardness measurement are presented in Table 5.

TABLE 5

| | | Ion | |
|---|---|---|---|
| | | Exchange | Vickers |
| Sample | Faceplate glass | condition | Hardness |
| Example 4 | Corning ATG glass | No | 560 |
| Example 5 | Corning Gorilla glass code 2320 | No | 534 |
| Example 10 | Corning Antimicrobial glass code | Yes, Ag⁺ | 649 |
| | 2319 | | |
| Example 11 | Corning Gorilla glass code 2320 | Yes, K⁺ | 649 |
| Counter | Unknown competitor glass | unknown | 520 |
| example 1 | | | |

As can be clearly seen the Vickers hardness of the thin glass faceplates (3,3′, 3*) utilized in the various radiation shielding glass articles is advantageously higher and provides a radiation shielding glass articles (100, 110, 120, 130) with higher Vickers hardness over the commercial available Counter example 1. The radiation shielding glass articles (100, 110, 120, 130), also represent an even greater improvement over commercially available Corning® Med-X® Glass and Corning® Med-Gamma® Glass radiation shielding glass that when measured provided a Vickers hardness of 370. It should also be noted that radiation shielding glass article Example 11 was measured for Y D65 Transmission and had a high transmission of 88.71% as noted in Table 2.

To further highlight the improvements provided to the radiation shielding glass articles (100, 110, 120, 130) made with thin glass faceplates (3, 3′, 3*) that were ion exchanged in a AgCl salt bath, samples were made and tested. The ion exchange process incorporates silver into the ion exchanged region. Thereafter trace amounts of silver ions (Ag⁺) leach to the surface (3a, 3b) of the thin glass faceplate (3, 3″, 3*) that was treated. The thin glass faceplate (3, 3″, 3*), was bonded to the radiation shielding glass (1), with the PVB bonding agent (2) to form a radiation shielding glass articles (100, 110, 120, 130) with a silver ion (Ag⁺) activated antibacterial surface.

Testing was preformed according to an international standard JIS Z 2801, which is a recognized industrial standard test protocol for measurement of antibacterial efficacy. The standard measure is by quantifying the survival of bacterial cells that have been held in intimate contact with the surface containing an antibacterial agent for 24 hours at 37° C./saturated humidity. The efficiency of the measurement is comparing the survival of bacteria on a treated sample with that achieved on an untreated (control) sample.

To further illustrate the advantageous antibacterial properties of the thin Ag⁺ ion exchanged glass faceplate (3) that was used to fabricate the radiations shielding glass article (100, 110, 120, 130), tests were conducted per the JIS Z 2801 standard with drug resistant bacteria Methicillin-resistant Staphylococcus aureus, (MRSA), Vancomycin-resistant enterococcus, (VRE) and against C. difficile endospores to quantify the beneficial antibacterial properties. The tests were specifically conducted on Example 10 and Example 11 (for comparison purposes) and results are reported in Table 6.

TABLE 6

| | | Example 10: | Example 11: |
|---|---|---|---|
| | | MED-X | MED-X |
| | | thickness | thickness |
| | Example | 8.30 mm | 8.30 mm |
| S. aureus | Control | 9.93E+06 | 9.93E+06 |
| (MRSA) | Control Log | 0 | 0 |
| 33591 | Reduction | | |
| | Avg. colonies/ | <6.67E+00 | 5.00E+05 |
| | sample | | |
| | Log reduction | >6.17 | 1.30 |
| E. faecalis | Control | 1.25E+05 | 1.25E+05 |
| (VRE) | Control Log | 0 | 0 |
| 51299 | Reduction | | |
| | Avg. colonies/ | <5E+00 | 3.75E+04 |
| | sample | | |
| | Log reduction | >5.23 | 1.36E+00 |
| C. difficile | Control | 1.60E+04 | 1.60E+04 |
| (endospores) | Control Log | 0 | 0 |
| | Reduction | | |
| | Avg. colonies/ | 5.67E+02 | 9.93E+03 |
| | sample | | |
| | Log reduction | 1.5 | 0.2 |

Example 10 is a radiation shielding glass article (100, 110, 120, 130) containing a thin glass faceplates (3, 3′, 3*) that was ion exchange in AgCl salt bath that provides silver (Ag⁺) ions to the surface (3a, 3b) of the thin glass faceplate (3, 3′, 3*). Example 11 is a radiation shielding glass article (100, 110, 120, 130) containing a thin glass faceplates (3, 3′, 3*) that was ion exchange in KCl salt bath that provides silver (K⁺) ions to the surface (3a, 3b) of the thin glass faceplate (3, 3′, 3*). As can be seen in Table 6, Example 10 provided a significant reduction on the average bacterial and endospore colonies in comparison to Example 11. Thus, radiation shielding glass article (100, 110, 120, 130) ion exchanged in AgCl having silver ions (Ag⁺) embedded in a surface, had a Log Reduction rate of >5 against the bacterial samples and a Log Reduction rate of >1.5 against the endospores.

Frit bonding is an alternative bonding technique known in the art that uses a low melting temperature glass as a bonding agent (2) in the production of the radiation shielding glass article (120). The bonding agent (2) is produced by mixing a finely powdered low melting temperature glass with a liquid to form a cohesive admixture of the solid glass particulates and the liquid used to form a uniform frit paste. The liquid is often referend to as a “vehicle” in the technology lexicon, meaning it is a means for conveniently and accurately delivering the frit paste to a desired location. The vehicle can be one or more liquids with low vapor pressures. Examples of such low vapor pressure liquids include but are not limited to water, ethanol, glycol, polyol or various organic oils or lubricating substances. The smooth frit paste can be accurately placed and uniformly dispensed either over a complete surface (1a, 1b, 3a, 3b) or preferentially in certain advantageous patterns via one or more syringes to deliver points or lines of frit paste, or by screen-printing techniques that known in the prior art. The frit paste bonding agent is designed to soften, flow, wick, and bond at temperatures below that of either the radiation shielding glass layer (1) or the thin glass faceplates (3).

FIG. 3 illustrates a radiation shielding glass article (120) produced with the frit bonding agent (2). The radiation shielding glass article (120), is formed from a sheet of radiation shielding glass (1), of dimensions 100 mm×100 mm with thickness of 4.0 mm. To the radiation shielding glass (1), a screen-printing mask was temporarily fixed to first surface (1a). An amount of a low melting temperature glass frit paste bonding agent (2) was applied to the mask and was squeegee across the mask to accurately place the bonding agent (2) into one or more recesses or openings in the screen-printing mask. The screen-printing mask is then removed to reveal bonding agent (2) placed at selected locations (A, B, C, . . . ) with the portion of bonding agents (2A, 2B, 2C, . . . ) located at each selected location on the first surface (1a) of the of radiation shielding glass (1). For clarity, in the process steps, radiation shielding glass (1) with the portion of bonding agents (2A, 2B, 2C, . . . ) placed upon it will be referred to as a radiation shielding glass (10). It may be beneficial with some bonding agents (2, 2A, 2B, 2C, . . . ), to pre-densify the bonding agent by dehydration or baking the radiation shielding glass (10) to actively remove some or all the liquid vehicle prior to the next assembly step.

A thin glass faceplate (3) was fabricated from larger sheet of ATG glass to produce a first thin glass faceplate (3) with dimension of 100 mm×100 mm and with thickness of 0.4 mm. The preliminary assembly of layers of the radiation glass article (120) are undertaken on a clean workbench. The radiation shielding glass layer (10) is positioned on the workbench. Then the first thin glass faceplate (3) is positioned onto the radiation shielding glass layer (10), such that the second surface (3b) of the first thin glass faceplate (3) is aligned with the first surface (1a) of the radiation shielding glass layer (10). Once aligned the two glass layers are brought together such that the bonding agents (2, 2A, 2B, 2C, . . . ) contact the first thin glass faceplate (3) to form a pre-assembly.

The now aligned pre-assembly may optionally be fixtured to prevent misalignment during further processing steps, or placed directly on a setter plate within an electric furnace and heated using a thermal cycle that causes the bonding agent (2, 2A, 2B, 2C, . . . ) to soften, flow, wick, and strongly bond, the radiation shielding glass layer (1) to the thin glass faceplates (3) to from radiation shielding glass article (120). Where the bonding agent is placed non-uniformly in a pattern along a boundary (2) or applied in a non-continuous fashion (2A, 2B, 2C, . . . ), the radiation shielding glass article (120) may form one of more first cavities between to the first surface (1a) of the radiation shielding glass (1) and the surface (3b) of the first thin glass faceplate (3). Additionally when a second thin glass faceplate (3) is use in the fabrication of the radiation shielding glass article (120) there may be formed one of more second cavities between to the first surface (1b) of the radiation shielding glass (1) and the first surface (3a) of the second thin glass faceplate (3). The first cavities and the second cavities may optionally be filled with polymer material chosen from PVB, EVA, epoxy, and UV curable polymers, or with a fluid chosen from air, nitrogen, argon, xenon, index matching oil, or combinations thereof, to form a radiation shielding glass article (120).

Thermal bonding is another known bonding technique for bonding glass objects. It is accomplished by stacking, placing or pressing selected glass layers in a desired order or position to make physical contact with each other, while applying heat to the object. FIG. 4 illustrates a radiation shielding glass article (130). The radiation shielding glass article (130), is formed from a sheet of radiation shielding glass (1), of dimensions 100 mm×100 mm and with thickness of 4.0 mm. Thin glass faceplates (3) were fabricated from a larger sheet of ATG glass to produce two identical 100 mm×100 mm thin glass faceplates with thickness of 0.4 mm.

The preliminary assembly of layers of the radiation shielding glass article (130) are undertaken on a clean workbench. The first thin glass faceplate (3), is positioned onto the radiation shield glass layer (1), such that the second surface (3b) of the first thin glass faceplate (3) is aligned with the first surface (1a) of the radiation shielding glass layer (1). Then the second thin glass faceplate (3), is positioned onto the radiation shielding glass layer (1), such that the first surface (3a) of the second thin glass faceplate (3) is aligned with the second surface (1b) of the radiation shielding glass layer (1). Once aligned the three glass layers were optionally fixtured for form a pre-assembly to prevent misalignment during further thermal bonding processing steps.

The pre-assembly is then placed on a setter plate within an electric furnace and heated using a thermal cycle that causes one or more of the radiation shielding glass layer (1) and the thin glass faceplates (3) to soften and form a strong bond between the adjacent first surface (1a) to second surface (3b) and between the second surface (1b) to first surface (3a). The later portion of the thermal cycle involves a slow cooling step to room temperature. The slow cooling step proceeded at a cooling rate of 25° C. per hour, but the rate could be anywhere from 1 to 100° C./hour depending on the glasses used.

Thermal bonding can occur with or without the use of added pressure or weight added to the pre-assembly during the heating cycle. It is believed that squeezing the stacked pre-assembly into more intimate contact, while the pre-assembly is heated in the electric furnace causes more molecular bonds to be formed between the adjacent glass surfaces. There are benefits and limitations to this bonding technique that are known in the art, but this can be a suitable assembly process for fabricating the radiation shielding glass article (130).

It should be noted that in some instance radiation shielding glass articles (100, 110, 120, 130) are produced in standardized large X-Y dimensional formats, enabled by the large radiation shielding glass (1) and large sized thin glass faceplate glass (3). This is commonly done to standardize production equipment, and to provide standardized products into the marketplace. It is obvious that the oversized standardized stock products can be used as a large radiation shielding glass articles (100, 110, 120, 130) of that dimension, or can be further subdivided divided into smaller equivalent radiation shielding glass articles (100, 110, 120, 130) to meet the demands of smaller X-Y form factor applications. In such instance the large radiation shielding glass articles (100, 110, 120, 130) can be sawn and edge finished into smaller equivalent radiation shielding glass articles (100, 110, 120, 130) fully described in this application.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the specific value or end-point referred to is included. Whether or not a numerical value or end-point of a range in the specification recites “about,” two embodiments are described: one modified by “about,” and one not modified by “about.” It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

Now therefore we claim the following:

1. A radiation shielding glass article, comprising:
a radiation shielding glass having a first surface and an opposing second surface; and
a first thin glass faceplate having a first surface and an opposing second surface, wherein one of said first surface or second surface of said first thin glass faceplate faces the first surface of the radiation shielding glass, wherein the first thin glass faceplate having a thickness of less than or equal to 1.0 mm is bonded to the first surface of the radiation shielding glass, and wherein the first thin glass faceplate is one of an alkaline boro-aluminosilicate glass, or a chemically strengthenable sodium aluminum silicate glass.

2. The radiation shielding glass article of claim 1, wherein the radiation shielding glass has a thickness of 3.5 mm to 60 mm.

3. The radiation shielding glass article of claim 1, wherein the radiation shielding glass comprises: SiO₂10-35 wt. %, PbO 50-80 wt. %, B₂O₃ 0-10 wt. %, Al₂O₃ 0-10 wt. %, BaO 0-20 wt. % SrO 0-10 wt. % the total of SrO+BaO 0-20 wt. %, Na₂O 0-10 wt. %, K₂O 0-10 wt. %, and Sb₂O₃ 0-0.8 wt. %.

4. The radiation shielding glass article of claim 1, where the radiation shielding glass comprises: SiO₂10-35 wt. % PbO 55-80 wt. %, B₂O₃ 0-10 wt. %, Al₂O₃ 0-10 wt. %, BaO 0-10 wt. %, SrO 0-10 wt. %, the total of SrO+BaO 0-20 wt. %, Na₂O 0-10 wt. %, and K₂O 0-10 wt. %

5. The radiation shielding glass article of claim 1, further comprising a first bonding agent configured to bond the radiation shielding glass and the first thin glass faceplate, wherein the first bonding agent is disposed between the first surface of the radiation shielding glass and the second surface of the first thin glass faceplate.

6. The radiation shielding glass article of claim 1, wherein the first thin glass faceplate is thermally bonded to the radiation shielding glass.

7. The radiation shielding glass article of claim 5, further comprising a first cavity defined by a first surface of the radiation shielding glass, the first bonding agent, and the second surface of the first thin glass faceplate, wherein the first cavity is filled with one of: a polymer material or a fluid, wherein the polymer material is at least one of PVB, EVA, epoxy, and UV curable polymers, and wherein the fluid is at least one of air, nitrogen, argon, xenon, and index matching oil.

8. The radiation shielding glass article of claim 1, wherein a Y D65 transmission of the radiation shielding glass article is greater than 80%.

9. The radiation shielding glass article of claim 1, wherein a transmission of greater that 80% is maintained across the 450 nm to 800 nm spectral band.

10. The radiation shielding glass article of claim 1, wherein the first thin glass faceplate has a Vickers hardness of greater than 530.

11. The radiation shielding glass article of claim 1, wherein the first thin glass faceplate has an ion exchanged surface having a Vickers hardness of greater than 600.

12. The radiation shielding glass article of claim 1, where in the first thin glass faceplate has an ion exchanged surface having a Vickers hardness of greater than 600 and has silver ions (Ag⁺) embedded in the ion exchanged surface.

13. The radiation shielding glass article of claim 1, further comprising:
a second thin glass faceplate having a first surface and an opposing second surface, wherein the first surface of the second thin glass faceplate faces the second surface of the radiation shielding glass, wherein the second thin glass faceplate having a thickness of less than 1.0 mm is bonded to the second surface of the radiation shielding glass, and wherein the second thin glass faceplate is one of an alkaline boro-aluminosilicate glass, or a chemically strengthenable sodium aluminum silicate glass.

14. The radiation shielding glass article of claim 13, further comprising a second bonding agent configured to bond the radiation shielding glass and the second thin glass faceplate wherein the second bonding agent is disposed between the second surface of the radiation shielding glass and the first surface of the second thin glass faceplate.

15. The radiation shielding glass article of claim 13, wherein the second thin glass faceplate is thermally bonded to the radiation shielding glass.

16. The radiation shielding glass article of claim 15, further comprising a second cavity defined by a second surface of the radiation shielding glass, the second bonding agent layer, and the first surface of the second thin glass faceplate, wherein the second cavity is filled with one of: a polymer material or a fluid, wherein the polymer material is at least one of PVB, EVA, epoxy, and UV curable polymers and wherein the fluid is at least one of air, nitrogen, argon, xenon, and index matching oil.

17. The radiation shielding glass article of claim 13, wherein a Y D65 transmission the radiation shielding glass article is greater than 80%

18. The radiation shielding glass article of claim 13, wherein a transmission greater than 80% is maintained across the 450 nm to 800 nm spectral band.

19. The radiation shielding glass article of claim 13, wherein the second thin glass faceplate has a Vickers hardness of greater than 530.

20. The radiation shielding glass article of claim 13, wherein the second thin glass faceplate has an ion exchanged surface having a Vickers hardness of greater than 600.

21. The radiation shielding glass article of claim 13, wherein the second thin glass faceplate having an ion exchanged surface having a Vickers hardness of greater than 600 and has silver ions (Ag⁺) embedded in the ion exchanged surface.
